(19) United States
(12) Patent Application Publication
(10) Pub. No.: US 2006/0003131 A1
(43) Pub. Date: Jan. 5, 2006

(54) Printed self-adhesive photo sheet

(75) Inventor: Mark E. Fagan, Loveland, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/159,054

(22) Filed: Jun. 22, 2005

Related U.S. Application Data
(60) Provisional application No. 60/585,062, filed on Jul. 2, 2004.

(51) Int. Cl. B32B 9/00

(52) U.S. Cl. 428/40.1; 428/203

(57) ABSTRACT

An indicia-bearing adhesive article display sheet includes a substrate having a first major side and a second major side, indicia, a layer of primer material, a layer of adhesive, and a transparent or translucent cover sheet. The indicia is disposed on at least a portion of the first major side of the substrate. The layer of primer material is disposed over the indicia on at least a first portion of the first major side of the substrate. The layer of adhesive is disposed over the primer material on the first major side of the substrate. The transparent or translucent cover sheet is aligned to cover at least the layer of adhesive on the first major side of the substrate. The cover sheet is repositionable relative to the layer of adhesive.

### CROSS REFERENCE TO RELATED APPLICATION

This application claims the benefit of U.S. Provisional Patent Application No. 60/585,062, filed Jul. 2, 2004.

### BACKGROUND OF THE INVENTION

The present invention relates to an indicia-bearing self-adhesive sheet. More particularly, the present invention relates to an indicia-bearing self-adhesive article display sheet suitable for use with a scrapbook.

Preparing scrapbooks is a popular pastime activity. Most generally, a scrapbook is a book, photo album, binder or other holder that allows users to store, organize and preserve materials such as photographs, newspaper clippings and memorabilia. A typical scrapbook includes one or more pages, with scrapbook articles (e.g., photographs) permanently or removably affixed to those pages. Scrapbook articles may be affixed to one or both sides of the scrapbook pages.

Scrapbook pages can be article display sheets or photo sheets that include a substrate, a layer of repositionable adhesive on the substrate, and a clear cover sheet. The repositionable adhesive permits users to removably secure articles to a photo sheet. The cover sheet is typically a transparent plastic material. Initially, the cover sheet is generally aligned with the substrate and operatively engaged with the substrate by the repositionable adhesive. A portion of the cover sheet typically extends over a portion of the substrate not coated by repositionable adhesive, which facilitates lifting the cover sheet from the substrate. Where the cover sheet is disengaged from the repositionable adhesive, users can secure articles on the repositionable adhesive. A user can then reposition the cover sheet over the articles removably attached to the repositionable adhesive. In this manner, photo sheets allow for storage, display and preservation of articles in a scrapbook, while still permitting removal of those articles without damage.

Photo sheets typically include a number of other common features. For instance, an attachment area having two or more holes can be provided near an edge of the photo sheet, for securing the photo sheet in a scrapbook having binder or post attachment components. The attachment area can be reinforced. In addition, alignment means, such as tape or adhesive, is typically included along an edge of the photo sheet opposite the attachment area. This alignment means helps minimize misalignment of the cover sheet relative to the substrate.

Users often put a great deal of effort into the arrangement and display of articles in a scrapbook. This can include adding decorative features. Arrangement and decoration of a scrapbook can be an elaborate process. In addition, users often desire to include notations on pages of a scrapbook. For instance, it is often desirable to include dates and narrative descriptions for certain scrapbook articles.

German Patent Application DE 35 08 807 A1 discloses a self-adhesive album sheet having an adhesive area and a separate printed memo area. However, the album sheet only discloses orienting masks.

Thus, the present invention provides an alternative indicia-bearing self-adhesive photo sheet.

### BRIEF SUMMARY OF THE INVENTION

An indicia-bearing adhesive article display sheet according to the present invention includes a substrate having a first major side and a second major side, indicia, a layer of primer material, a layer of adhesive, and a transparent or translucent cover sheet. The indicia is disposed on the first major side of the substrate. The layer of primer material is disposed over the indicia on at least a first portion of the first major side of the substrate. The layer of adhesive is disposed over the primer material on the first major side of the substrate. The transparent or translucent cover sheet is aligned to cover at least the layer of adhesive on the first major side of the substrate. The cover sheet is repositionable relative to the layer of adhesive.

A method of positioning an article relative to indicia on a substrate of a self-adhesive photo sheet is also presented.

### BRIEF DESCRIPTION OF THE DRAWINGS

FIG. 1 is a plan view of a photo sheet.

FIG. 2 is a cross-sectional view of a portion of the photo sheet as taken along line 2-2 in FIG. 1.

FIG. 3 is a plan view of another photo sheet.

FIG. 4 is a plan view of another photo sheet.

FIG. 5 is a cross-sectional view of a portion of the photo sheet as taken along line 5-5 in FIG. 4.

While the above-identified drawing figures set forth several embodiments of the invention, other embodiments area also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

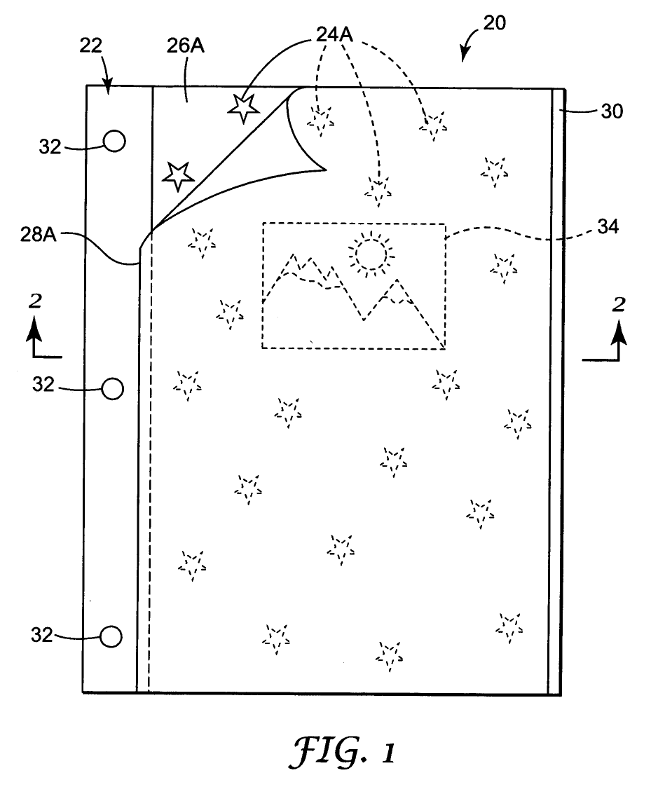

FIG. 1 is a plan view of a photo sheet 20 (synonymously called a scrapbook article display sheet, a self-adhesive photo page and a “magnetic” page). The photo sheet 20 includes a substrate 22, indicia 24A, an adhesive 26A, a first cover sheet 28A, alignment means 30, and a number of holes 32. As shown in FIG. 1, an article 34 is disposed between the adhesive 26 and the first cover sheet 28A. Article 34 could be, for example, a photograph or a scrapbooking article, such as a lock of hair.

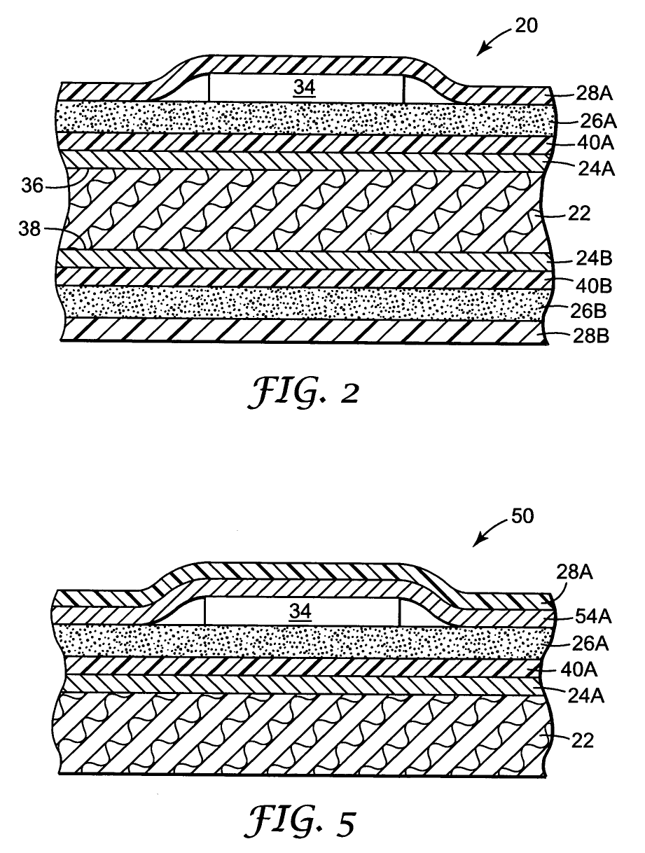

FIG. 2 is a cross-sectional view of a portion of the photo sheet 20 as taken along line 2-2 in FIG. 1. As seen in FIG. 2, the substrate 22 of the photo sheet 20 further includes a first major side 36 and an opposite second major side 38. The first major side 36 includes indicia 24A, a layer of primer materials 40A, an adhesive 26A, and a first cover sheet 28A. The second major side 38 of the substrate 22, similar to the first major side 36, includes indicia 24B, a layer of primer materials 40B, an adhesive 26B, and a second cover sheet 28B.

The substrate 22 is generally formed as a sheet. Dimensions of the substrate 22 will vary according to the particular application with which the photo sheet 20 will be used. For instance, in one embodiment, the substrate 22 has overall length and width dimensions of 9 inches (in.) (22.86 cm) by 11 in. (27.94 cm). In another embodiment, the substrate 22 has overall length and width dimensions of 11 in. (27.94 cm) by 11 in. (27.94 cm). The substrate 22 can be formed of any ink-receptive web of material, and is typically heavyweight acid-free paper. In further embodiments, the substrate 22 can be coated paper (e.g., paper coated with clay or other ink-receptive coatings), cardboard, synthetic papers such as “Yupo” (a filled polypropylene material, available from Yupo Corporation America, Chesapeake, Va.), polypropylene, and polyester films.

The photo sheet 20 has indicia 24A and 24B disposed on the first and second major sides 36 and 38 of the substrate 22. Indicia 24A and 24B can include nearly any desired pattern, such as text, an image (e.g., a picture frame image), and a decorative background design. In further embodiments, indicia 24A and 24B can entirely cover at least one side of the substrate 22. FIG. 1 provides an exemplary embodiment of the photo sheet 20 where indicia 24A on the first major side 36 of the substrate 22 is arranged as a decorative background design of star shapes. Indicia 24B on the second major side 38 of the photo sheet 20 is identical to indicia 24A on the first major side 36. In further embodiments, indicia 24A and 24B on the first and second major sides 36 and 38 can differ as to the type and arrangement of the respective patterns.

Indicia 24A is typically ink deposited on the substrate 22. Ink can be deposited on the photo sheet 20 by conventional printing techniques. One or more kinds of ink can be used. For instance, indicia 24A can include four ink colors printed on the substrate 22. Where multiple ink colors are used, each ink color is typically printed separately in a sequential process, as will be known to those skilled in the art.

The layer of primer material 40A is generally disposed over indicia 24A on at least a portion of the first major side 36 of the substrate 22. The layer of adhesive 26A is disposed over the primer material 40A on the first major side 36 of the substrate 22. The primer 40B and the adhesive 26B are applied relative to the second major side 38 of the substrate 22 in a similar manner.

The adhesives 26A and 26B are typically repositionable adhesives, such as is exemplified by the adhesives used on Post-it® brand notes, manufactured by 3M Company, St. Paul, Minn. The repositionable adhesives can be acrylic- or rubber-based pressure sensitive adhesives. In a preferred embodiment, the adhesives 26A and 26B are repositionable pressure sensitive acrylic adhesives that are non-damaging to photographs. The adhesives 26A and 26B are typically applied continuously over at least a portion of the substrate 22. In further embodiments, the adhesives 26A and 26B can be applied as a pattern coating, for instance, as patterns of stripes and dots.

The adhesives 26A and 26B are generally applied in the range from about 2 to about 25 grams/meter². For example, an acrylic microsphere repositionable adhesive is typically applied from about 2 to about 10 grams/meter².

The primer materials 40A and 40B can be any material suitable for facilitating bonding of the adhesives 26A and 26B to the substrate 22. Preferably, the primer material is an acid-free and photograph safe material. The primers 40A and 40B allows stronger bonding between the adhesives 26A and 26B and the substrate 22 than between the adhesives 26A and 26B and other objects, such as the scrapbook article 34 and the first cover sheet 28A. Stronger bonding between the adhesives 26A and 26B and the substrate 22 establishes a bonding preference that helps to avoid undesirable removal of portions of the adhesives 26A and 26B from the substrate 22. Typical primer materials include solvents (including water), polymers and inorganic particles. In one embodiment, the primer materials 40A and 40B include a vinyl chloride polymer and zinc oxide primer commercially designated VAGH, available from Union Carbide Corporation, Danbury, Conn.

Prior to use, the first cover sheet 28A is generally aligned to cover at least the layer of adhesive 26A on the first major side 36 of the substrate 22. As shown in FIG. 1, a portion of the cover sheet 28A is disengaged or “peeled away” from the adhesive 26A (i.e., leaving a portion of the layer of adhesive 26A uncovered). In one embodiment, the first cover sheet 28A extends beyond the layer of adhesive 26A on the first major side 36 of the substrate 22 by about 0.25 inches (in.) (0.635 cm). This provides a portion of the first cover sheet 28A not secured to the adhesive 26A for a user to better grasp the first cover sheet 28A. The first cover sheet 28A is repositionable relative to the layer of adhesive 26A on the first major side 36 of the substrate 22.

In a preferred embodiment, the photo sheet 20 is two-sided, permitting attachment of scrapbook articles relative to both the first and second major sides 36 and 38 of the substrate 22. The second cover sheet 28B is positioned relative to the second major side 38 of the substrate 22 and is generally similar to the first cover sheet 28A. Descriptions of the first cover sheet 28A apply equally to the second cover sheet 28B. When manufacturing a two-sided photo sheet, typically one side is fabricated followed by the other side in a continuous manufacturing process.

Both the first and second cover sheets 28A and 28B are generally transparent or translucent, and are formed of acid-free and photograph safe materials such as cast or oriented polypropylene, polyethylene and polyester. In a preferred embodiment, the first and second cover sheets 28A and 28B are formed of biaxially oriented polypropylene (BOPP).

The first and second cover sheets 28A and 28B generally have a thickness of about 1 mil (0.0254 mm) to about 3.5 mils (0.0889 mm). In a preferred embodiment, the first and second cover sheets 28A and 28B each have a thickness of about 2 mils (0.0508 mm). Stiffness of cover sheets varies as the cube of the thickness of the sheet. Sufficient stiffness has a number of desirable qualities, such as minimizing undesired wrinkling of the first and second cover sheets 28A and 28B after repeated engagement with the adhesives 26A and 26B, respectively.

The first and second cover sheets 28A and 28B are capable of being positioned over the respective adhesives 26A and 26B and any scrapbook articles affixed thereon. Scrapbook articles affixed to the adhesives 26A and 26B are generally visible through the first and second cover sheets 28A and 28B.

Alignment means 30 is attached to the first cover sheet 28A and positioned along an edge of the substrate 22. In the embodiment shown in FIG. 1, alignment means 30 is a strip of tape attached to both the first and second cover sheets 28A and 28B along an edge of the substrate 22. Those skilled in the art will recognize that connecting means 30 can take other forms. In a further embodiment, alignment means 30 includes tape and hot melt glue for connecting the first and second cover sheets 28A and 28B. In yet another embodiment, alignment means 30 includes providing a folded-over portion of at least one of the cover sheets and hot melt glue for connecting the first and second cover sheets 28A and 28B.

Because a user typically detaches only one cover sheet (e.g., the first cover sheet 28A) from the adhesives (e.g., the adhesive 26A) at a time, the other cover sheet (e.g., the second cover sheet 28B) remains secured to adhesive (e.g., the adhesive 26B). Alignment means 30 connects the first and second cover sheets 28A and 28B for reducing a risk that a user would entirely detach the first or the second cover sheet 28A or 28B from the substrate 22, which creates a substantial risk of misalignment. Generally speaking, alignment means 30 reduces the risk of misalignment of the first and the second cover sheets 28A and 28B by reducing the time and effort required by a user to reposition a cover sheet relative to the respective adhesive 26A and 26B on either side of the substrate 22.

The article (or scrapbook article) 34, shown in FIGS. 1 and 2, is an exemplary item such as a photograph, newspaper clipping or other item suitable for use with a scrapbook. A variety of items can be removably affixed to the photo sheet 20. Typically, such items are relatively small and relatively flat. Users can attach numerous scrapbook articles to a single photo sheet in a desired arrangement. In addition, users can add decorative and utilitarian embellishments, such as string, raffia, and labels, which can be affixed to the adhesives 26A and 26B on the substrate 22 or secured to the photo sheet 20 using other attachment means (e.g., adhesive tie downs, brads, string and glue). These embellishments are utilized, if at all, according to each user's particular tastes and preferences. For instance, it is possible for users to attach decorative embellishments to outer portions of the first and second cover sheets 28A and 28B to enhance a presentation of scrapbook articles removably affixed to the adhesives 26A and 26B.

The holes 32 are typically disposed in the substrate 22 and are typically located near an edge of the photo sheet 20. The holes 32 can be used for securing the photo sheet 20 in a scrapbook (not shown) having binder or post attachment components. The binder or post attachment components extend through the holes 32 to secure the photo sheet 20 in the scrapbook. Any number of holes 32 can be included, and the number, size and placement of the holes 32 will depend on the type of scrapbook the photo sheet 20 is intended to be used with. The holes 32 are optional, and can be excluded where not needed to secure the photo sheet 20 in a scrapbook. In one exemplary embodiment, the photo sheet 20 includes three substantially circular holes 32 for use with binder attachment components of a scrapbook (e.g., a standard three-ring binder). The holes 32 are 0.375 in. (0.9525 cm) in diameter. A hole 32 is centered along a length of the photo sheet 20 and the remaining holes 32 are spaced 4.25 in. (10.795 cm), measured center-to-center, on either side thereof.

In operation, a user can detach the first cover sheer 28A of the photo sheet 20 from the adhesive 26A on the first major side 36 of the substrate 22. The user can then removably affix the scrapbook article 34 to the adhesive 26A. The scrapbook article 34 can generally be placed anywhere in contact with a portion of the adhesive 26A, as desired. Additional scrapbook articles can also be removably affixed to the adhesive 26A on the first major side 36 of the substrate 22.

The user is able to place the scrapbook article 34 in a desired position relative to indicia 24A. After the scrapbook article 34 is removably affixed to the adhesive 26A, the first cover sheet 28A is removably affixed to the adhesive 26A, in operative engagement therewith. The first cover sheet 28A covers the scrapbook article 34 and generally conforms around any raised features of the scrapbook article 34. At least one portion of the first cover sheet 28A is then removably affixed to the adhesive 26A on the first major side 36 of the substrate 22. The scrapbook article 34 generally arranged to be viewable through the first cover sheet 28A, when the first cover sheet 28A is repositioned over the scrapbook article 34. Securing the first cover sheet 28A over the scrapbook article 34 can assist in securing the scrapbook article 34 to the substrate 22. The first cover sheet 28A further provides some protection of the scrapbook article 34, for preserving the scrapbook article 34 during storage. For example, the first cover sheet 28A can prevent the scrapbook article 34 from touching an adjacent photo sheet where the photo sheet 20 is placed in a scrapbook.

The scrapbook article 34 can be removed from the photo sheet 20 by reversing the process identified above. The first cover sheet 28A is detached or peeled away from the adhesive 26A and then the scrapbook article 34 is removed from the adhesive 26A. The first cover sheet 28A can then be repositioned in alignment with the layer of adhesive 26A.

Operation of the photo sheet 20 for affixing and removing scrapbook articles to and from the second major side 38 of the substrate 22 is substantially the same as that described above with respect to the first major side 36 of the substrate 22.

FIG. 3 is a plan view of a photo sheet 42. The photo sheet 42 includes similar features as the photo sheet 20 shown in FIGS. 1 and 2, and further includes a printed memo indicia area 44. The printed memo indicia area 44 provides space free from adhesive for a user to write data on the photo sheet 42. In further embodiments, printed memo indicia area 44 may include a separate substrate affixed to the adhesive 26A. The separate substrate can have an outer side free from adhesive, which creates a space on the photo page 20 that is functionally free from adhesive.

The printed memo indicia area 44 accepts markings from instruments such as pens, pencils, markers, crayons and stamps. In one embodiment, the printed memo indicia area 44 includes a plurality of 1.25 in. (3.175 cm) wide lines arranged in a columnar fashion and spaced 0.375 in. (0.9525 cm) apart. The printed memo indicia area 44 can be disposed on the substrate 22 to one side of the layer of adhesive 26A. In further embodiments, the printed memo indicia area 44 is disposed between two regions of adhesive on a major side of the substrate 22.

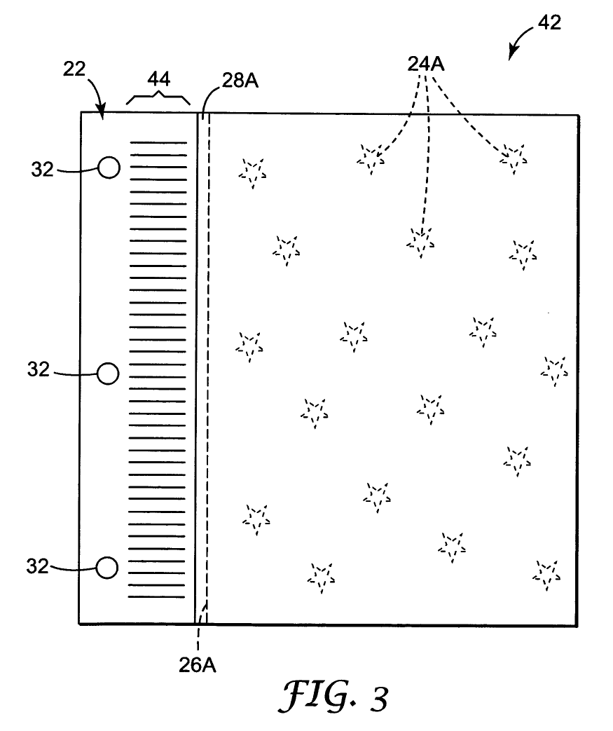

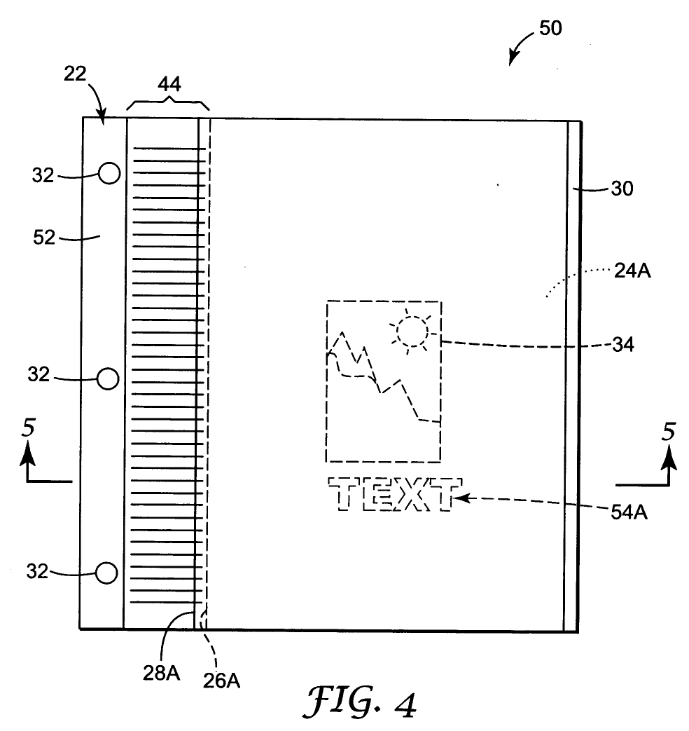

FIG. 4 is a plan view of a photo sheet 50. FIG. 5 is a cross-sectional view of a portion of the photo sheet 50 as taken along line 5-5 in FIG. 4. The photo sheet 50 includes features similar to the photo sheets 20 and 42 shown in FIGS. 1-3, and further includes a reinforcement 52 and indicia 54A disposed on the cover sheet 28A.

As seen in FIG. 4, the reinforcement 52 is disposed near the holes 32 on the substrate 22. In one embodiment, the reinforcement 52 is a tape strip disposed along an edge of the substrate 22 with holes corresponding to the holes 32 disposed in the tape strip. Where the photo sheet 50 is secured in a scrapbook with post or binder attachment components, significant wear and damage to the substrate 22 (e.g., tearing) is possible at or near the holes 32. The reinforcement 52 provides some protection to the substrate and reduces a risk that the photo sheet 50 will disengage from a scrapbook due to damage, such as tearing.

In the embodiment shown in FIG. 4, indicia 54A is disposed on the cover sheet 28A. In one embodiment, indicia 54A is disposed on an underside of the cover sheet 28A, generally between the cover sheet 28A and the substrate 22. In further embodiments, indicia 54A can be disposed on an outer side of the cover sheet 28A, such that the cover sheet 28A is generally disposed between the indicia 54A and the adhesive 26A. Indicia 54A can be of nearly any type and arrangement. In the embodiment shown in FIG. 4, indicia 54A is text. In various embodiments, indicia 54A can be opaque or translucent ink.

Indicia 54A on the cover sheet 28A can be arranged for cooperative visual arrangement with indicia on the substrate 22. For example, complex cooperative visual arrangements are possible, such as photo sheets with different designs printed on the substrate 22 and the cover sheet 28A where the different designs produce a coordinated design effect when the cover sheet 28A is operatively engaged with the adhesive 26A on the substrate 22. Additionally, the indicia on the cover sheet and substrate can be made to cooperate, mimic, or incorporate indicia and on the cover of the photo album (or scrapbook) holding the self-adhesive photo sheet.

It is also possible to arrange any of the embodiments of the self-adhesive photo sheet described above in a scrapbook. The scrapbook includes a plurality of scrapbook pages. In one embodiment, all the scrapbook pages include the same type of indicia. In another embodiment, different indicia is included on different scrapbook pages.

It is possible to include different types of pages bound or held together in a single scrapbook. The scrapbook can include any combination of printed self-adhesive photo sheets, pocket pages (i.e., a substrate and at least one pocket, such as a photograph-sized pocket, attached thereto for holding scrapbook articles), and “plain” scrapbook pages (i.e., a substrate not necessarily including any pockets or adhesives for securing scrapbook articles to the “plain” scrapbook page). Each of the pages in the scrapbook can include indicia disposed thereon.

Although the present invention has been described with reference to preferred embodiments, workers skilled in the art will recognize that changes may be made in form and detail without departing from the spirit and scope of the invention. For instance, arrangement of indicia can vary according to a desired pattern.

1. An indicia-bearing adhesive article display sheet comprising:
a substrate having a first major side and a second major side;
indicia disposed on at least a portion of the first major side of the substrate;
a layer of primer material disposed over the indicia on at least a first portion of the first major side of the substrate;
a layer of adhesive disposed over the primer material on the first major side of the substrate; and
a first transparent or translucent cover sheet aligned to cover at least the layer of adhesive on the first major side of the substrate.

2. The display sheet of claim 1 and further comprising:
indicia disposed on at least a portion of the second major side of the substrate;
a layer of primer material disposed over the indicia on at least a first portion of the second major side of the substrate;
a layer of adhesive disposed over the primer material on the second major side of the substrate; and
a second transparent or translucent cover sheet aligned to cover at least the layer of adhesive on the second major side of the substrate, wherein the cover sheet is repositionable relative to the layer of adhesive.

3. The display sheet of claim 2, wherein the first and second cover sheets are connected.

4. The display sheet of claim 2 and further comprising a tape strip attached to the first and second cover sheets and disposed at or near an edge of the substrate for minimizing misalignment of the first and second cover sheets relative the substrate.

5. The display sheet of claim 1, wherein a second portion of the first major side of the substrate is free of adhesive.

6. The display sheet of claim 5, wherein the second portion of the first major side of the substrate includes a printed memo indicia area thereon.

7. The display sheet of claim 1, wherein the adhesive is substantially transparent and/or translucent.

8. The display sheet of claim 1, wherein the adhesive is repositionable pressure sensitive adhesive.

9. The display sheet of claim 1, wherein the indicia is printed ink.

10. The display sheet of claim 1 and further comprising:
indicia disposed on the cover sheet.

11. The display sheet of claim 1, wherein the indicia on the first major side of the substrate is aligned in a cooperative visual arrangement with the indicia on the cover sheet.

12. An improved adhesive photo sheet including a substrate sheet, an adhesive covering at least part of the substrate sheet, and a cover sheet repositionable relative the substrate sheet, the improvement comprising:
an ink printed in a desired pattern on the substrate, wherein the ink is disposed substantially between the substrate and the adhesive.

13. A scrapbooking page comprising:
a substrate, wherein the substrate is an acid-free and photograph safe material, and wherein the substrate is formed as a sheet;
an ink printed directly on the substrate;
a repositionable adhesive disposed on the substrate, wherein the repositionable adhesive is capable of covering the ink;
a cover sheet capable of operative engagement with the repositionable adhesive, and wherein the scrapbooking page is capable of retaining small objects engaged between the adhesive material and the cover sheet.

14. The scrapbooking page of claim 13 and further comprising a primer material disposed between the substrate and the repositionable adhesive.

15. A method of positioning an article on a self-adhesive photo sheet including a substrate sheet, an adhesive covering at least part of the substrate sheet, and a cover sheet repositionable relative the substrate sheet, the method comprising:
providing indicia disposed substantially between the substrate sheet and the adhesive, wherein indicia is arranged in a desired pattern;
removably affixing the article on the adhesive, wherein the article is placed in a desired position relative to the desired pattern of the layer of indicia; and
placing the cover sheet over the scrapbook article and the adhesive.
